(19) United States
(12) Patent Application Publication
(10) Pub. No.: US 2020/0280080 A1
(43) Pub. Date: Sep. 3, 2020

(54) FUEL CELL SYSTEM

(71) Applicant: TOYOTA JIDOSHA KABUSHIKI KAISHA, Toyota-shi (JP)

(72) Inventors: Yukihide YOKOYAMA, Toyota-shi (JP); Yutaka SAWADA, Nagakute-shi (JP)

(73) Assignee: TOYOTA JIDOSHA KABUSHIKI KAISHA, Toyota-shi (JP)

(21) Appl. No.: 16/736,904

(22) Filed: Jan. 8, 2020

(30) Foreign Application Priority Data
Mar. 1, 2019 (JP) 2019-037111

(51) Int. Cl. H01M 8/04089; H01M 8/04007; H01M 8/2465

(52) U.S. Cl. CPC H01M 8/04097; H01M 2250/402; H01M 8/2465; H01M 8/04067

(57) ABSTRACT

The fuel cell system according to the present disclosure includes: a pressure reducing valve provided in a fuel supply pipe constituting a flow path for a fuel gas between main stop valves and injectors; a high-pressure communication pipe provided so as to communicate a first flow path with a second flow path, the first and the second flow paths being the fuel supply pipes serving as flow paths for the fuel gases sent from fuel gas tank units among the fuel supply pipes upstream of the pressure reducing valve, respectively; and a low-pressure communication pipe provided so as to communicate a third flow path with a fourth flow path, the third and the fourth flow paths being the fuel supply pipes serving as flow paths for the fuel gases supplied to fuel cell stacks among the fuel supply pipes downstream of the pressure reducing valve, respectively.

### CROSS REFERENCE TO RELATED APPLICATIONS

This application is based upon and claims the benefit of priority from Japanese patent application No. 2019-037111, filed on Mar. 1, 2019, the disclosure of which is incorporated herein in its entirety by reference.

### BACKGROUND

The present disclosure relates to a fuel cell system, and relates to a fuel cell system that supplies fuel gas from a plurality of fuel gas tanks to a plurality of fuel cells.

In recent years, a fuel cell system, which uses, as a power source, a fuel cell that generates electric power by a fuel gas and an oxidant gas being reacted with each other in an automobile or the like, has been widely used. In such a fuel cell system, a plurality of fuel gas tanks and a plurality of fuel cell stacks are coupled to each other through pipes in order to increase the amount of electric power generation in the system. Further, in such a fuel cell system, when a plurality of fuel gas tanks and a plurality of fuel cell stacks are coupled to each other through pipes, the pressures of the fuel gas tanks provided in parallel to each other are made uniform by coupling pipes for sending gas from the fuel gas tanks provided in parallel to each other. Japanese Unexamined Patent Application Publication No. 2018-14177 discloses an example of such a fuel cell system.

The fuel cell system disclosed in Japanese Unexamined Patent Application Publication No. 2018-14177 includes a communication path that connects fuel supply paths of adjacent fuel cell units to each other, and an opening and closing mechanism that opens and closes the communication path. Further, a path opening and closing control unit of a fuel cell system 1 is configured to control the operation of the opening and closing mechanism so that the pressure difference between the fuel tanks of the adjacent fuel cell units is reduced. Thus, it is possible to prevent the fuel gas from being excessively charged in some fuel tanks by making the respective pressures of the fuel tanks of the fuel cell units equal to each other.

### SUMMARY

However, the fuel cell system disclosed in Japanese Unexamined Patent Application Publication No. 2018-14177 has a problem that when the pressure of the fuel gas tank becomes lower than the opening pressure of a pressure reducing valve, and when the consumption of the fuel gas of one fuel cell stack is higher than that of the other fuel cell stack, the possibility of occurrence of a sealing failure due to the mixing of foreign matter is increased by the fuel gas flowing backward to the pressure reducing valve provided to correspond to the one fuel cell stack of which the pressure has been reduced.

The present disclosure has been made to solve the above-described problem, and an object thereof is to improve the reliability of a pressure reducing valve provided in a fuel cell system.

A first exemplary aspect is a fuel cell system, including: first and second fuel gas tank units each configured to store a fuel gas; first and second fuel cell stacks each configured to generate electric power by the fuel gas being supplied thereto; a main stop valve provided inside each of the first and second fuel gas tank units and configured to control whether to send the fuel gas; first and second injectors each configured to adjust an amount and a timing of supply of the fuel gas to the respective first and second fuel cell stacks, the first and second injectors being provided to correspond to the first and second fuel cell stacks, respectively; a fuel supply pipe configured to constitute a flow path of the fuel gas between the main stop valves in the first and second fuel gas tank units and the first and second injectors; a pressure reducing valve provided in the fuel supply pipe and configured to adjust a pressure of the fuel gas; a high-pressure communication pipe provided so as to communicate a first flow path with a second flow path, the first and the second flow paths being the fuel supply pipes serving as flow paths for the fuel gases sent from the first and the second fuel gas tank units among the fuel supply pipes upstream of the pressure reducing valve, respectively; and a low-pressure communication pipe provided so as to communicate a third flow path with a fourth flow path, the third and the fourth flow paths being the fuel supply pipes serving as flow paths for the fuel gases supplied to the first and the second fuel cell stacks among the fuel supply pipes downstream of the pressure reducing valve, respectively.

With the fuel cell system according to the present disclosure, by using the low-pressure communication path provided downstream of the pressure reducing valve, it is possible to allow gas, which is generated by the backflow of the fuel gas caused by the pressure difference between the first and the second fuel cell stacks, to flow from a high-pressure fuel cell stack side to a low-pressure fuel cell stack side without using the pressure reducing valve.

According to the present disclosure, it is possible to improve the reliability of a pressure reducing valve provided in a fuel cell system.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a configuration diagram of a fuel cell system according to a first embodiment;

FIG. 2 is a configuration diagram of the fuel cell system according to a comparative example;

FIG. 3 is a configuration diagram of the fuel cell system according to a second embodiment;

FIG. 4 is a diagram for explaining a problem with an operation of injectors in the fuel cell system according to the second embodiment; and

FIG. 5 is a diagram for explaining a method for controlling the injectors in the fuel cell system according to the second embodiment.

### DESCRIPTION OF EMBODIMENTS

### First Embodiment

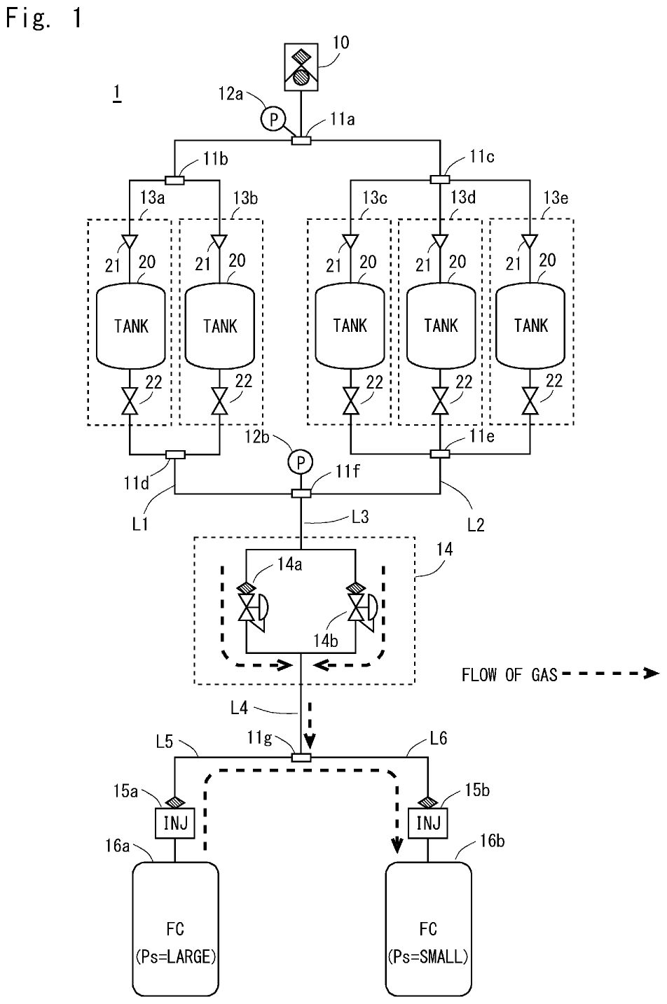

First, FIG. 1 shows a configuration diagram of a fuel cell system 1 according to a first embodiment. As shown in FIG. 1, the fuel cell system 1 according to the first embodiment includes a filling port 10, manifolds 11a to 11g, pressure sensors 12a and 12b, fuel gas tank units 13a to 13e, a pressure reducing valve 14, a first injector (e.g., an injector 15a), a second injector (e.g., an injector 15b), a first fuel cell stack (e.g., a fuel cell stack 16a), and a second fuel cell stack (e.g., a fuel cell stack 16b).

The filling port 10 is a connecting port for filling the fuel tank in the fuel cell system 1 with a fuel gas from an external fuel gas tank. The manifolds 11a to 11g are pipe connecting components for joining and branching pipes in the fuel cell system 1. The pressure sensor 12a detects the pressure of a fuel gas supplied from the filling port 10 to each of the fuel gas tank units 13a to 13e. Further, the pressure sensor 12b detects the pressure of a fuel gas sent from each of the fuel gas tank units 13a to 13e. The fuel gas tank units 13a to 13e each store a fuel gas, and each send the stored fuel gas in accordance with an instruction from the outside. Note that in the example shown in FIG. 1, the fuel gas tank units 13a and 13b are coupled to each other in parallel and constitute a first fuel gas tank unit, and the fuel gas tank units 13c to 13e are coupled to each other in parallel and constitute a second fuel gas tank unit.

It should be noted that the fuel gas tank units 13a to 13e each include a fuel gas tank 20, a check valve 21, and a main stop valve 22. The fuel gas tank 20 is a tank that stores a fuel gas. The check valve 21 allows a fuel gas supplied from the filling port 10 to the fuel gas tank 20 to flow from the filling port 10 toward the fuel gas tank 20, and prevents a backflow of the fuel gas from the fuel gas tank 20 to the filling port 10. The main stop valve 22 performs switching to determine whether or not the fuel gas is sent from the fuel gas tank 20 to the fuel cell stacks 16a and 16b.

The pressure reducing valve 14 reduces the pressure of the fuel gases sent from the fuel gas tank units 13a to 13e and sends them toward the fuel cell stacks 16a and 16b. In the example shown in FIG. 1, the pressure reducing valve 14 includes a first pressure reducing valve 14a and a second pressure reducing valve 14b. However, the number of pressure reducing valves that constitutes the pressure reducing valve 14 is determined by the relation between the allowable flow rate per one pressure reducing valve and the amount of gas that flows through the pipe in which the pressure reducing valve 14 is provided. That is, the number of pressure reducing valves included in the pressure reducing valve 14 can be one.

The injectors 15a and 15b are provided to correspond to the fuel cell stacks 16a and 16b, respectively, and each of these injectors adjusts the amount and timing of supply of the fuel gas to a respective one of the fuel cell stacks 16a and 16b. Each of the fuel cell stacks 16a and 16b generates electric power by the fuel gas being supplied thereto.

The pipes that connect components constituting the fuel cell system 1 to one another are described below with reference to FIG. 1. As shown in FIG. 1, the fuel gas filled via the filling port 10 is distributed to two branched pipes by the manifold 11a. One of the branched pipes is connected to the first fuel gas tank unit constituted of the fuel gas tank units 13a and 13b, and the other is connected to the second fuel gas tank unit constituted of fuel gas tank units 13c to 13e. Further, in the fuel gas tank units 13a and 13b, the pipes at the respective input sides are connected to each other by the manifold 11b, and the fuel gas is supplied to each of the fuel gas tank units through the manifold 11b. In the fuel gas tank units 13c to 13e, the pipes at the respective input sides are connected to one another by the manifold 11c, and the fuel gas is supplied to each of the fuel gas tank units through the manifold 11c.

In the fuel gas tank units 13a and 13b, the pipes at the respective output sides are connected to each other by the manifold 11d, and the fuel gas is sent to each of the fuel gas tank units through the manifold 11d. Then, the fuel gases, which are sent through the pipes connected to the main stop valves 22 of the fuel gas tank units 13a and 13b, are joined by the manifold 11d, and are provided to the manifold 11f through one pipe. In the fuel gas tank units 13c to 13e, the pipes at the respective output sides are connected to one another by the manifold 11e, and the fuel gas is sent to each of the fuel gas tank units through the manifold 11e. Further, the fuel gases sent through the pipes connected to the main stop valves 22 of the fuel gas tank units 13c to 13e are joined by the manifold 11e, and are provided to the manifold 11f through one pipe. The manifold 11f joins the fuel gases sent from the fuel gas tank units 13a to 13e and sends them to the pressure reducing valve 14.

It should be noted that in the fuel cell system 1 according to the first embodiment, fuel supply pipes constituting flow paths for a fuel gas are provided between the main stop valves 22 of the fuel gas tank units 13a to 13e and the injectors 15a and 15b. Further, among the fuel supply pipes upstream of the pressure reducing valve 14, the fuel supply pipe serving as a flow path for the fuel gases sent from the fuel gas tank units 13a and 13b is defined as a first flow path L1. Further, among the fuel supply pipes upstream of the pressure reducing valve 14, the fuel supply pipe serving as a flow path for the fuel gases delivered from the fuel gas tank units 13c to 13e is defined as a second flow path L2. Furthermore, the first flow path L1 is connected to the second flow path L2 by the manifold 11f so that the fuel gases sent through the first and the second flow paths L1 and L2 are sent to one pipe (e.g., a high-pressure communication pipe L3). That is, the high-pressure communication pipe L3 is provided so as to communicate the first flow path L1 with the second flow path L2.

Further, among the fuel supply pipes downstream of the pressure reducing valve 14, the fuel supply pipe serving as a flow path for the fuel gases supplied to the fuel cell stack 16a is defined as a third flow path L5. Further, among the fuel supply pipes downstream of the pressure reducing valve 14, the fuel supply pipe serving as a flow path for the fuel gases supplied to the fuel cell stack 16b is defined as a fourth flow path L6. Furthermore, in the example shown in FIG. 1, the fuel gas sent from the pressure reducing valve 14 is sent to the manifold 11g through a low-pressure communication pipe L4, and is branched into the third and the fourth flow paths L5 and L6 by the manifold 11g. That is, in the example shown in FIG. 1, the third and the fourth flow paths L5 and L6 are provided so as to communicate with each other through the low-pressure communication pipe L4.

In other words, in the fuel cell system 1 according to the first embodiment, an outlet of the first flow path L1 and an outlet of the second flow path L2 are connected to each other. Further, one end of the high-pressure communication pipe L3 is connected to the part of the first flow path L1 to which the second flow path L2 is connected. Further, an inlet of the third flow path L5 and an inlet of the fourth flow path L6 are connected to each other. Further, one end of the low-pressure communication pipe L4 is connected to the part of the third flow path L4 to which the fourth flow path L5 is connected. Furthermore, in the fuel cell system 1 according to the first embodiment, the pressure reducing valve 14 is provided so as to be sandwiched between the other end of the high-pressure communication pipe L3 and the other end of the low-pressure communication pipe L4.

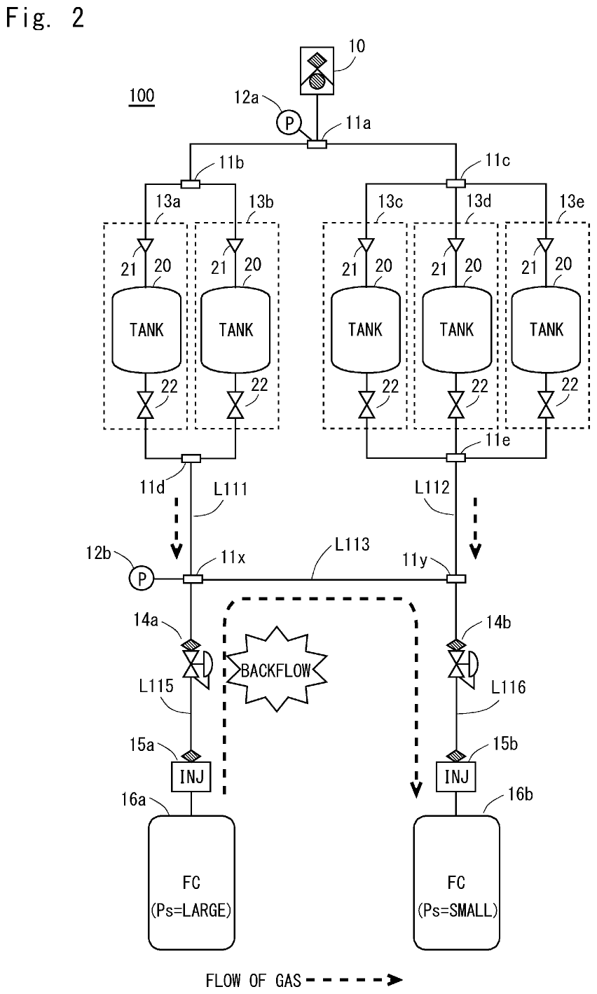

The above-described fuel cell system 1 according to the first embodiment improves the reliability of the pressure reducing valve 14 by preventing a backflow to the pressure reducing valve 14. Therefore, an effect of preventing the backflow to the pressure reducing valve 14 in the fuel cell system 1 according to the first embodiment is described with reference to a fuel cell system 100 according to a comparative example shown in FIG. 2.

FIG. 2 is a configuration diagram of the fuel cell system 100 according to the comparative example. As shown in FIG. 2, in the fuel cell system 100 according to the comparative example, the fuel gases sent from the fuel gas tank units 13a and 13b are sent to the first pressure reducing valve 14a through a first flow path L111. Further, the fuel gases sent from the fuel gas tank units 13c to 13e are sent to the second pressure reducing valve 14b through a second flow path L112. Further, the fuel gas of which the pressure is reduced by the first pressure reducing valve 14a is sent to the injector 15a through a third flow path L115. The fuel gas of which the pressure is reduced by the second pressure reducing valve 14b is sent to the injector 15b through a fourth flow path L116. Further, in the fuel cell system 100 according to the comparative example shown in FIG. 2, the first flow path L111 is connected to the second flow path L112 by a high-pressure communication pipe L113. On the other hand, in the fuel cell system 100 according to the comparative example, the third flow path L115 and the fourth flow path L116 are not connected and are independent from each other.

Further, in this fuel cell system 100 according to the comparative example, when the internal pressure of one of the fuel cell stacks 16a and 16b becomes lower than that of the other in a state where the fuel gases stored in the fuel gas tank units 13a to 13e are reduced and the pressures of the fuel gases sent from the fuel gas tank units 13a to 13e are reduced, a backflow (a flow in the direction from the fuel cell stack toward the fuel gas tank unit) of the fuel gas to the pressure reducing valve occurs. In the example shown in FIG. 2, the internal pressure of the fuel cell stack 16b is lower than that of the fuel cell stack 16a. Further, in the example shown in FIG. 2, a path, through which the fuel gas flows from the injector 15a provided to correspond to the fuel cell stack 16a toward the injector 15b provided to correspond to the fuel cell stack 16b through the high-pressure communication pipe L13, is generated. Further, when this flow of the fuel gas is generated, a backflow to the first pressure reducing valve 14a occurs. It should be noted that such a backflow to the first pressure reducing valve 14a may cause a failure due to foreign matter mixing in the seal of the pressure reducing valve 14.

On the other hand, unlike in the fuel cell system 100 according to the comparative example, in the fuel cell system 1 according to the first embodiment shown in FIG. 1, a backflow to the pressure reducing valve 14 does not occur. As shown in FIG. 1, in the fuel cell system 1 according to the first embodiment, the flow of fuel gas is generated, when the internal pressure of the fuel cell stack 16b becomes lower than that of the fuel cell stack 16a, in an area in which the low-pressure communication pipe L4, the third flow path L5, and the fourth flow path L6 downstream of the pressure reducing valve 14 are closed. That is, in the fuel cell system 1 according to the first embodiment, a backflow of fuel gas to the pressure reducing valve 14 does not occur.

As described above, in the fuel cell system 1 according to the first embodiment, the high-pressure communication pipe L3 that communicates the pipes supplying the fuel gas to the injectors to each other is provided downstream of the pressure reducing valve 14. By doing so, in the fuel cell system 1 according to the first embodiment, even when the pressure of the fuel gas sent from the fuel gas tank unit is reduced and an internal pressure difference between different fuel cell stacks develops, it is possible to prevent a backflow of the fuel gas to the pressure reducing valve 14. Accordingly, the lifetime of the pressure reducing valve 14 and the reliability thereof can be improved.

### Second Embodiment

In a second embodiment, a fuel cell system 2 that is a modified example of the fuel cell system 1 according to the first embodiment will be described. Note that in the description of the second embodiment, the components described in the first embodiment are denoted by the same reference symbols as those in the first embodiment, and the description thereof will be omitted.

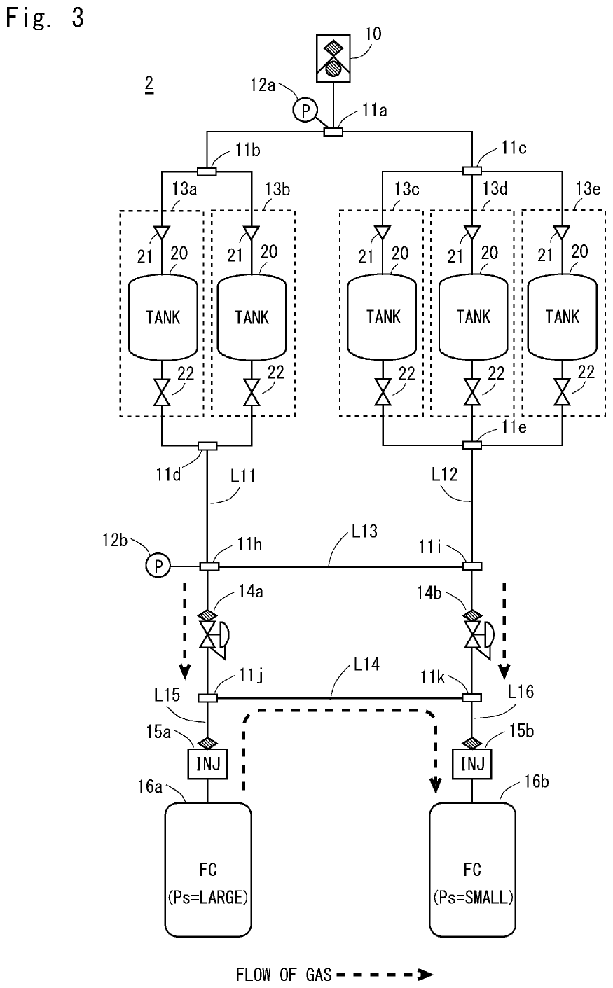

FIG. 3 shows a configuration diagram of the fuel cell system according to the second embodiment. As shown in FIG. 3, the fuel cell system 2 according to the second embodiment is different from the first embodiment in regard to the pipe connection relation of the fuel supply pipes. Specifically, in the fuel cell system 2 according to the second embodiment, the fuel gases sent from the fuel gas tank units 13a and 13b are sent to the first pressure reducing valve 14a through a first flow path L11. Further, the fuel gases sent from the fuel gas tank units 13c to 13e are sent to the second pressure reducing valve 14b through a second flow path L12. Further, the fuel gas of which the pressure is reduced by the first pressure reducing valve 14a is sent to the injector 15a through a third flow path L15. The fuel gas of which the pressure is reduced by the second pressure reducing valve 14b is sent to the injector 15b through a fourth flow path L16. Further, in the fuel cell system 2 according to the second embodiment shown in FIG. 3, the first flow path L11 is connected to the second flow path L12 by a high-pressure communication pipe L13. Further, in the fuel cell system 2 according to the second embodiment, the third flow path L15 and the fourth flow path L16 are connected to each other by a low-pressure communication pipe L14.

Note that as shown in FIG. 2, the first flow path L11 is connected to the high-pressure communication pipe L13 by a manifold 11h. The second flow path L12 is connected to the high-pressure communication pipe L13 by a manifold 11i. The third flow path L15 is connected to the low-pressure communication pipe L14 by a manifold 11j. The fourth flow path L16 is connected to the low-pressure communication pipe L14 by a manifold 11k.

That is, in the fuel cell system 2 according to the second embodiment, the first pressure reducing valve 14a is provided at the end of the outlet side of the first flow path L11, and the second pressure reducing valve 14b is provided at the end of the outlet side of the second flow path L12. Further, the first flow path L11 and the second flow path L12 are connected to each other by the high-pressure communication pipe L13. Further, the third flow path L15 is provided so as to connect the first pressure reducing valve 14a to the first injector 15a, and the fourth flow path L16 is provided so as to connect the second pressure reducing valve 14b to the second injector 15b. Furthermore, the low-pressure communication pipe L14 is provided so as to connect the third flow path L15 to the fourth flow path L16.

As described above, in the fuel cell system 2 according to the second embodiment, the pipes downstream of the first and the second pressure reducing valves 14a and 14b are connected to each other by the low-pressure communication pipe L14. By doing so, like in the fuel cell system 1 according to the first embodiment, in the fuel cell system 2 according to the second embodiment, backflows of fuel gases to the first and the second pressure reducing valves 14a and 14b can be prevented.

Further, one of the features of the fuel cell system 2 according to the second embodiment is a method for operating the injectors 15a and 15b. Therefore, a problem that may occur due to the method for operating the injectors in the fuel cell system 2 will be described.

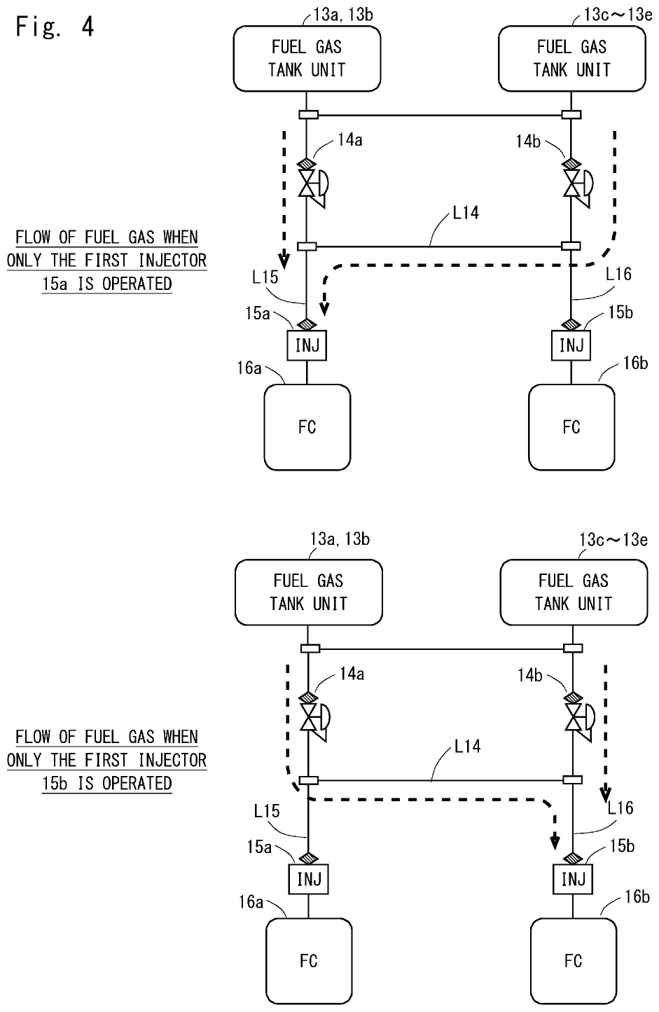

FIG. 4 shows a diagram for explaining a problem with an operation of the injectors in the fuel cell system according to the second embodiment. As shown in FIG. 4, when the injectors 15a and 15b are operated at timings different from each other in the fuel cell system 2 according to the second embodiment, both of the first and the second pressure reducing valves 14a and 14b are operated in response to operating one of the injectors. Accordingly, when the injectors 15a and 15b are operated at timings different from each other as in the example shown in FIG. 4, the number of operations of the first and the second pressure reducing valves 14a and 14b becomes more than the number of operations of the injectors, thereby causing a problem that the respective lifetimes of the components to be set become different from each other.

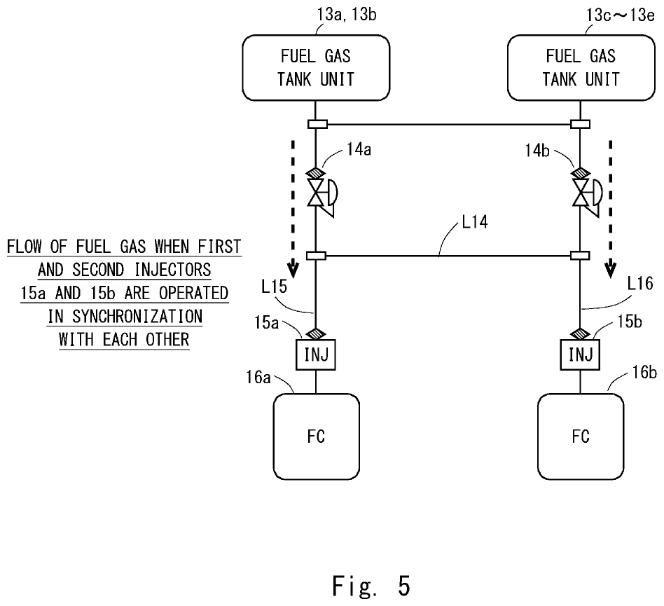

Therefore, in the fuel cell system 2 according to the second embodiment, when one of the injectors 15a and 15b is operated, the other injector is also simultaneously operated. FIG. 5 shows a diagram for explaining a method for controlling the injectors in the fuel cell system according to the second embodiment. As shown in FIG. 5, in the fuel cell system 2 according to the second embodiment, it is possible to prevent the number of operations of the pressure reducing valves from increasing by simultaneously operating the injectors 15a and 15b.

As described above, in the fuel cell system 2 according to the second embodiment, it is possible to prevent the number of operations of the first and the second pressure reducing valves 14a and 14b from increasing by simultaneously operating the injectors 15a and 15b when they are operated. Accordingly, in the fuel cell system 2 according to the second embodiment, it is possible to set the durability of the components or the lifetimes thereof to be uniform.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A fuel cell system comprising:
first and second fuel gas tank units each configured to store a fuel gas;
first and second fuel cell stacks each configured to generate electric power by the fuel gas being supplied thereto;
a main stop valve provided inside each of the first and second fuel gas tank units and configured to control whether to send the fuel gas;
first and second injectors each configured to adjust an amount and a timing of supply of the fuel gas to the respective first and second fuel cell stacks, the first and second injectors being provided to correspond to the first and second fuel cell stacks, respectively;
a fuel supply pipe configured to constitute a flow path of the fuel gas between the main stop valves in the first and second fuel gas tank units and the first and second injectors;
a pressure reducing valve provided in the fuel supply pipe and configured to adjust a pressure of the fuel gas;
a high-pressure communication pipe provided so as to communicate a first flow path with a second flow path, the first and the second flow paths being the fuel supply pipes serving as flow paths for the fuel gases sent from the first and the second fuel gas tank units among the fuel supply pipes upstream of the pressure reducing valve, respectively; and
a low-pressure communication pipe provided so as to communicate a third flow path with a fourth flow path, the third and the fourth flow paths being the fuel supply pipes serving as flow paths for the fuel gases supplied to the first and the second fuel cell stacks among the fuel supply pipes downstream of the pressure reducing valve, respectively.

2. The fuel cell system according to claim 1, wherein
an outlet of the first flow path and an outlet of the second flow path are connected to each other,
one end of the high-pressure communication pipe is connected to a part of the first flow path to which the second flow path is connected,
an inlet of the third flow path and an inlet of the fourth flow path are connected to each other,
one end of the low-pressure communication pipe is connected to a part of the third flow path to which the fourth flow path is connected, and
the pressure reducing valve is provided so as to be sandwiched between the other end of the high-pressure communication pipe and the other end of the low-pressure communication pipe.

3. The fuel cell system according to claim 1, wherein
the pressure reducing valve comprises:
a first pressure reducing valve provided at an end of an outlet side of the first flow path; and
a second pressure reducing valve provided at an end of an outlet side of the second flow path,
the first flow path and the second flow path are connected to each other by the high-pressure communication pipe,
the third flow path is provided so as to connect the first pressure reducing valve to the first injector,
the fourth flow path is provided so as to connect the second pressure reducing valve to the second injector, and
the low-pressure communication pipe is provided so as to connect the third flow path to the fourth flow path.

4. The fuel cell system according to claim 1, wherein the first injector and the second injector are controlled so that when one of the injectors is operated, the other injector is also operated in synchronization with the one injector.
